(19) United States
(12) Patent Application Publication
(10) Pub. No.: US 2006/0218250 A1
(43) Pub. Date: Sep. 28, 2006

(54) Client terminal device and client server system

(75) Inventor: Takafumi Nakase, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/387,984

(22) Filed: Mar. 24, 2006

(30) Foreign Application Priority Data
Mar. 25, 2005 (JP) 2005-087786

(51) Int. Cl. G06F 15/16

(52) U.S. Cl. 709/219

(57) ABSTRACT

A client terminal device and a client server system that can receive operation signals at more suitable timing are provided. In the client server system equipped with a client terminal device and a server device that is connected with the client terminal device through a wireless network, the client terminal device is provided with a buffer that stores content information corresponding to the operation signals from a remote controller sent by the server device, a reception regulation program making CPU inhibit reception of the operation signals sent from the remote controller by the signal reception unit until completion of outputting of the content information temporarily stored in the buffer to an output device after one operation signal has been received from the remote controller, and an informing unit informing inhibition of reception of the operation signals during inhibition.

### BACKGROUND OF THE INVENTION

1. Field of the Invention

The present invention relates to a client terminal device and a client server system.

2. Description of the Related Art

In recent years, a system for providing a client terminal device with information (content information) from a server device through a network has been used. A plurality of kinds of audio visual (AV) apparatuses such as a television device, a video recorder, a personal video recorder (PVR), a tuner for the broadcasting satellite (BS) broadcast or the communication satellite (CS) broadcast, a set top box (STB), a digital versatile disk (DVD) player, an audio device and the like is connected to the server device. The system is configured to be able to transfer the content information corresponding to the AV equipment connected to the server device from the server device to the client terminal device.

Here, a user of the client terminal device operates the client terminal device, for example, by depressing the input buttons provided in a remote controller (hereinafter referred to as a remote) for the client terminal device. Some kinds of operations require a long time after the user has depressed the input buttons of the remote until the performances of the operations corresponding to the operations of the input buttons are conducted. In this case, the user will misguidedly think that no operation signals have been transmitted to the client terminal device, and will unnecessarily depress the input buttons of the remote continuously, for example. As a result, the client terminal device has the problems such that the operation of the client terminal device stops, or that the client terminal device performs its operations excessively to cause a result that the user does not desire. In addition, the client terminal device also has the problem that the user will misguidedly think that no operation signals have been transmitted to the client terminal device and feel uneasy.

Accordingly, for example, the method disclosed in Patent Document 1, and the like have been proposed. In the method, after a client terminal device has received a certain operation signal, the client terminal device inhibits the reception of the succeeding operation signals for a certain period. And then, after the certain period has elapsed, the client terminal device cancels the inhibition and allows to receive the succeeding operation signals.

Patent document 1: Tokukaisho 56-42859

However, the method disclosed in Patent Document 1 causes the following problem in some particular lengths of the certain periods. That is, despite the noncompletion of the operation corresponding to a certain operation signal in the client terminal device, the client terminal device receives the next operation signal. Or, despite the completion of the operation corresponding to a certain operation signal in the client terminal device, the client terminal device does not receive the next operation signal. Moreover, the problem in which a user misguidedly think that no operation signals have been transmitted to the client terminal device and feel uneasy cannot be solved.

### SUMMARY OF THE INVENTION

It is an object of the present invention to provide a client terminal device and a client server system that can receive operation signals at more suitable timing.

In order to achieve the above object, a client server system of the present invention comprises: a client terminal device; further comprising: a signal reception section to receive operation signals sent from a remote controller; a signal transmission section to send the operation signals received by the signal reception section to a server device; a storage section to temporarily store output information corresponding to the operation signals sent by the signal transmission section, the output information sent from the server device; an output control section to control outputting the output information stored in the storage section to output section; a reception regulation section to inhibit reception of the operation signals sent from the remote controller by the signal reception section, until completion of outputting the output information temporarily stored in the storage section to the output section after reception of one operation signal from the remote controller; and an informing section to inform inhibition while the reception regulation section inhibits reception of the operation signals; and the server device connected with the client terminal device through a wireless network to send and receive information; further comprising: an output information obtainment section to obtain the output information corresponding to the operation signals sent by the signal transmission section; and an information transmission section to send the output information obtained by the output information obtainment section to the client terminal device.

In order to achieve the above object, a client terminal device of the present invention that sends and receives information with a server device connected to the client terminal device through a wireless network, comprises: a signal reception section to receive operation signals sent from a remote controller; a signal transmission section to send the operation signals received by the signal reception section to the server device; a storage section to temporarily store output information corresponding to the operation signals sent by the signal transmission section, the output information sent from the server device; an output control section to control outputting the output information stored in the storage section to output section; and a reception regulation section to inhibit reception of the operation signals sent from the remote controller by the signal reception section, until completion of outputting the output information temporarily stored in the storage section to the output section after reception of one operation signal from the remote controller.

Preferably, the reception regulation section calculates a time required until all of the output information is outputted to the output section, based on an amount of the output information stored in the storage section at a point of time when the signal reception section received the one operation signal from the remote controller, and inhibits reception of the operation signals sent from the remote controller by the signal reception section until the time calculated elapse.

Preferably, the reception regulation section puts a mark on output information which is lastly outputted to the output section, among the output information stored in the storage section at a point of time when the signal reception section received the one operation signal from the remote controller, and inhibits reception of the operation signals sent from the remote controller by the signal reception section until the output information which is lastly outputted, with the mark on, is outputted to the output section.

Preferably, the reception regulation section obtains a residual quantity of the output information stored in the storage section at a point of time when the signal reception section received the one operation signal from the remote controller, and inhibits reception of the operation signals sent from the remote controller by the signal reception section until an amount of the output information outputted to the output section since a point of time when the residual quantity has been obtained, exceeds the residual quantity.

Preferably, the client terminal device further comprises an informing section to inform inhibition while the reception regulation section inhibits reception of the operation signals.

According to the first aspect of the present invention, the reception of the operation signals, transmitted from the remote controller, at the signal reception section can be inhibited by the reception regulation section until completion of outputting the output information temporarily stored in the storage section to the output section, after one operation signal has been received from the remote controller. That is, even when a user unnecessarily operates the remote controller and unnecessary operation signals are transmitted from the remote controller, the signal reception section of the client terminal device does not receive the unnecessary operation signals. Consequently, the client terminal device does not perform the operations that the user does not desire, unlike the conventional client terminal device. Moreover, since the period of inhibiting the reception of the operation signals is not limited to a certain period, unlike the conventional client terminal device, the operation signals can be received at more suitable timing.

Moreover, during the inhibition of the reception of the operation signals by the reception regulation section, the inhibition can be informed by the information section. Consequently, the problem that the user thinks that the operation signals might not be transmitted to the client terminal device and feel uneasy can be solved.

According to the second aspect of the present invention, the reception of the operation signals, transmitted from the remote controller, at the signal reception section can be inhibited by the reception regulation section until completion of outputting the output information temporarily stored in the storage section to the output section, after the one operation signal has been received from the remote controller. That is, even when a user unnecessarily operates the remote controller and unnecessary operation signals are transmitted from the remote controller, the signal reception section of the client terminal device does not receive the unnecessary operation signals. Consequently, the client terminal device does not perform the operations that the user does not desire, unlike the conventional client terminal device. Moreover, since the period of inhibiting the reception of the operation signals is not limited to a certain period, unlike the conventional client terminal device, the client terminal device can receive the operation signals at more suitable timing.

According to the third aspect of the present invention, it is a matter of course that the similar advantages to those of the second aspect can be achieved. Besides, the reception regulation section calculates the time required until all of the output information have been outputted to the output section, based on the amount of the output information stored in the storage section at the point of time when the signal reception signal received the one operation signal from the remote controller. Therefore the reception regulation section can inhibit the reception of the operation signals transmitted from the remote controller by the signal reception section until the calculated time has elapsed. Consequently, the operation signals received by the signal reception section after the one operation signal are valid operation signals that had been transmitted after the ascertainment of the completion of the output of the output information corresponding to the operation signals received by the signal reception section prior to the one operation signal. Consequently, the client terminal device can receive the operation signals at more suitable timing.

According to the fourth aspect of the present invention, it is a matter of course that the similar advantages to those of the second aspect can be achieved. Besides, the reception regulation section can put a mark to the output information that is lastly outputted to the output section in the output information stored in the storage section at the point of time when the signal reception section receives the one operation signal from the remote controller. Therefore the reception regulation section can inhibit the reception of the operation signals transmitted from the remote controller by the signal reception section until the output information with the mark is outputted to the output section. Consequently, the operation signals received by the signal reception section after the one operation signal are valid operation signals that has been transmitted after the ascertainment of the completion of the output of the output information corresponding to the operation signals received by the signal reception section prior to the one operation signal. Consequently, the client terminal device can receive the operation signals at more suitable timing.

According to the fifth aspect of the present invention, it is a matter of course that the similar advantages to those of the second aspect can be achieved. Besides, the reception regulation section can obtain the residual quantity of the output information stored in the storage section at the point of time when the signal reception section receives the one operation signal from the remote controller. Therefore the reception regulation section can inhibit the reception of the operation signals transmitted from the remote controller by the signal reception section until the amount of the output information outputted to the output section from the point of time when the residual quantity has been obtained. Consequently, the operation signals received by the signal reception section after the one operation signal are valid operation signals that had been transmitted after the ascertainment of the completion of the output of the output information corresponding to the operation signals received by the signal reception section prior to the one operation signal. Consequently, the client terminal device can receive the operation signals at more suitable timing.

According to the sixth aspect of the present invention, it is a matter of course that the similar advantages to those of any one of the second to the fifth aspects can be achieved. Besides, the inhibition of the reception of the operation signals by the reception regulation section can be informed with the information section during the inhibition. Consequently, the problem in which a user thinks that no operation signals might be transmitted to the client terminal device and feel uneasy can be solved.

### BRIEF DESCRIPTION OF THE DRAWINGS

The present invention will become more fully understood from the detailed description given hereinbelow and the accompanying drawings which are given by way of illustration only, and thus are not intended as a definition of the limits of the present invention, and wherein;

FIG. 1 is a diagram showing the configuration of the entire client server system of an embodiment of the present invention;

FIG. 2 is a block diagram showing the functional configuration of a server device in the embodiment of the present invention;

FIG. 3 is a block diagram showing the functional configuration of a client terminal device in the embodiment of the present invention;

FIG. 4 is a flowchart for illustrating the processing pertaining to the reception regulation of operation signals from a remote by the client terminal device of the client server system;

FIG. 5 is a flowchart for illustrating a first modified example of the processing pertaining to the reception regulation of the operation signals from the remote by the client terminal device of the client server system; and

FIG. 6 is a flowchart for illustrating a second modified example of the processing pertaining to the reception regulation of the operation signals from the remote by the client terminal device of the client server system.

### DETAILED DESCRIPTION OF THE PREFERRED EMBODIMENTS

In the following, the best mode for implementing the present invention is described in detail by reference to the attached drawings. Here, the scope of the invention is not limited to the shown examples.

<Configuration>

The configurations of a client server system, a server device and a client terminal device are described.

[Configuration of Client Server System]

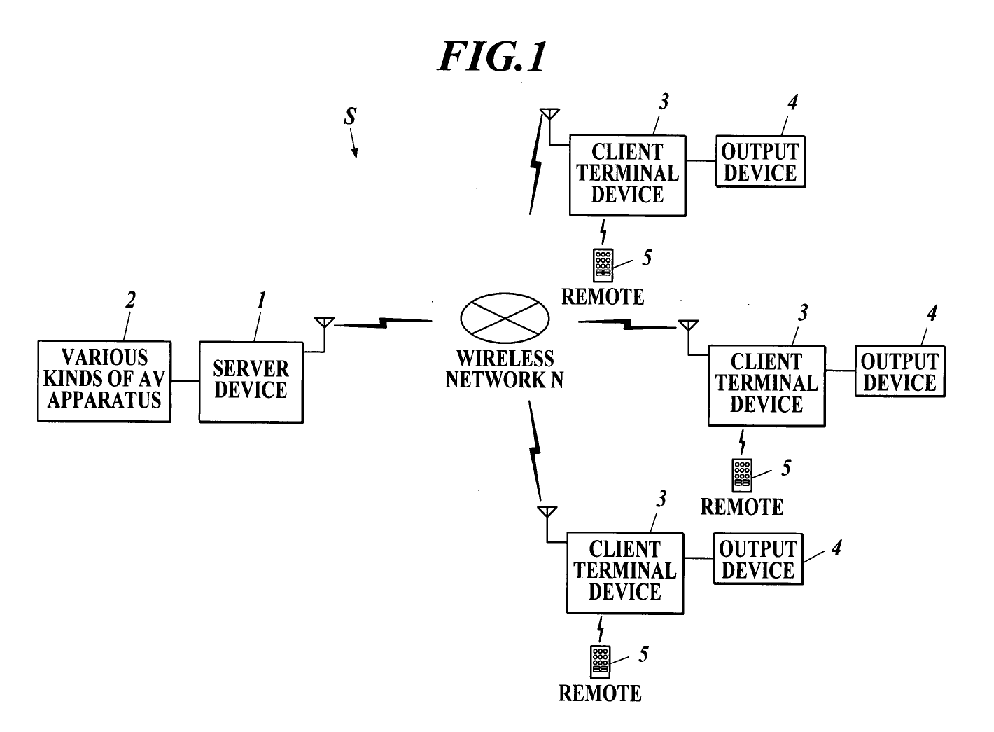

For example, as shown in FIG. 1, a client server system S comprises a server device 1 connected with various kinds of AV apparatus 2, a plurality of client terminal device 3, each of which is connected with an output device 4 as output section and is capable of being operated by a remote controller 5 (hereinafter referred to as a remote 5), and the like. The server device 1 and the client terminal device 3 are connected with each other through a wireless network N, and the client server system S is configured to enable the server device 1 and the client terminal device 3 to send and receive information mutually.

Here, the number of the client terminal device 3 to the server device 1 is not limited to that of FIG. 1.

As for an example the information transmitted from the client terminal device 3 to the server device 1, there are operation signals. In particular, operation signals are transmitted from the remote 5 to a client terminal device 3 according to the depression of the input buttons provided on the remote 5 by a user, and the operation signals are transmitted from the client terminal device 3 to the server device 1. The operation signals are, for example, a signal for operating the server device 1 and the client terminal device 3.

As for an example of the information transmitted from the server 1 to the client terminal device 3, there is output information. The output information is, for example, the content information obtained from the various kinds of AV apparatus 2 connected with the server device 1 to be outputted to one of the output device 4 connected to the corresponding client terminal device 3.

In particular, for example, when it is instructed by the operation signal to output the content information (output information) that the user desires to the output device 4, the client terminal device 3 sends the operation signal to the server device 1. The server device 1, which has received the operation signal, obtains the content information (output information) that corresponds with the operation signal and is desired by the user from the various kinds of AV apparatus 2, and sends the obtained content information (output information) to the client terminal device 3. Then, the client terminal device 3 outputs the received content information (output information) to the output device 4. In this way, the content information is supplied from the server device 1 to the client terminal device 3.

The wireless network N is a network such as a wireless local area network (LAN) according to the Bluetooth standard or the Institute of Electrical and Electronic Engineers (IEEE) 802.11 standard.

[Configuration of Server Device]

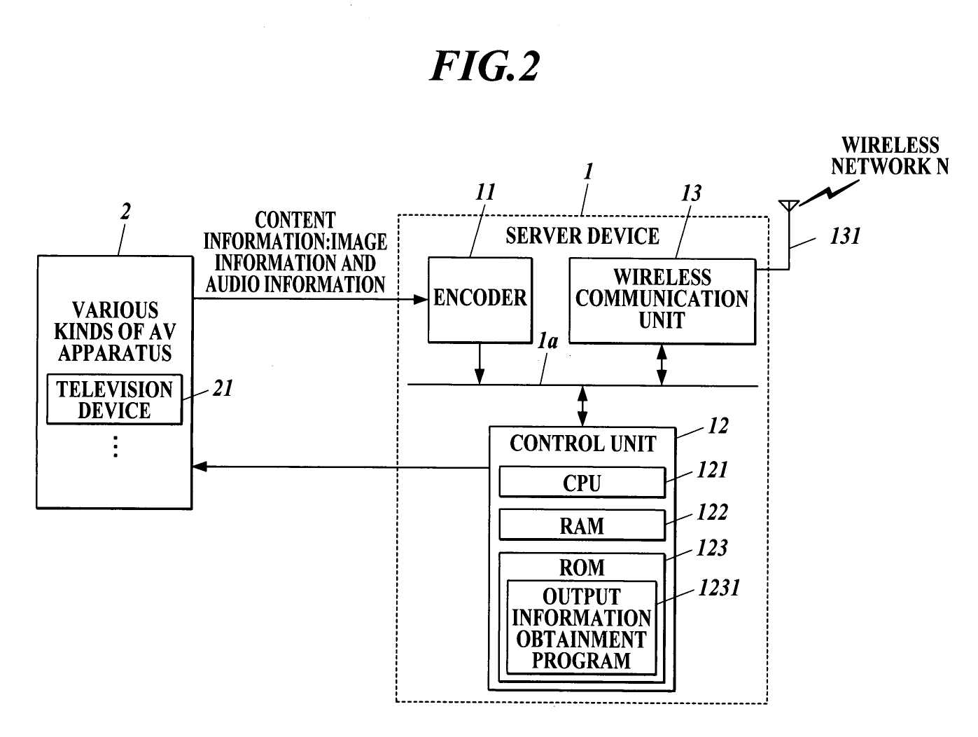

As shown in FIG. 2, the server device 1 comprises, for example, an encoder 11, a control unit 12, a wireless communication unit 13, and the like. Each unit is connected with each other through a bus 1a. Further, the server device 1 is connected with the various kinds of AV apparatus 2.

The encoder 11 encodes the content information (image information and audio information) as the output information that is inputted, for example, from the various kinds of AV apparatus 2 into compressed content information (compressed image information and compressed audio information) as output information in a predetermined file format, and outputs the encoded compressed content information. In particular, for example, the encoder 11 encodes the image information inputted from the various kinds of AV equipment 2 into compressed image information in the Moving Picture Experts Group phase 2 (MPEG-2) format or the like, and encodes the audio information inputted from the various kinds of AV apparatus 2 into compressed audio information in the Advanced Audio Coding (AAC) format or the like.

The control unit 12 comprises, for example, as shown in FIG. 2, a central processing unit (CPU) 121, a random access memory (RAM) 122, a read only memory (ROM) 123, and the like.

The CPU 121 performs various control operations according to various processing programs stored in the ROM 123 for the server device 1.

The RAM 122 is provided with a program storage region to expand the processing program to be executed by the CPU 121 and the like, and a data storage region to input data, a processing result produced at the time of the execution of the processing program, and the like.

The ROM 123 stores the system program executable by the server device 1, the various processing programs executable by the system program, the data used at the time of the execution of the various processing programs, the data of the processing results of the operation processing by the CPU 121, and the like. Here, the programs are stored in the ROM 123 in the form of the program codes capable of being read by a computer.

In particular, for example, as shown in FIG. 2, an output information obtainment program 1231 and the like are stored in the ROM 123.

The output information obtainment program 1231 makes the CPU 121 actualize the function of obtaining the content information according to the operation signal sent by a wireless communication unit 32 (which will be described later) as signal transmission section of one of the client terminal device 3.

In particular, for example, when the wireless communication unit 13 receives an operation signal sent by the wireless communication unit 32 of the client terminal device 3, the CPU 121 executes the output information obtainment program 1231, and controls the various kinds of AV apparatus 2 to make the various kinds of AV apparatus 2 output the content information according to the operation signal to the encoder 11 of the server device 1. Subsequently, the various kinds of AV apparatus 2 outputs the content information according to the operation signal to the encoder 11 corresponding to the control.

The CPU 121 functions as output information obtainment section by executing the output information obtainment program 1231.

The wireless communication unit 13 sends and receives various kinds of information with the client terminal device 3 through the wireless network N. In particular, the wireless communication unit 13 is provided with an antenna 131 to send and receive radio signals with the client terminal device 3, a radio frequency (RF) converter (not shown), a wireless LAN card (not shown) for the connection with a wireless LAN according to the Bluetooth standard and the IEEE 802.11 standard, and the like.

In particular, the wireless communication unit 13 in the present invention, for example, receives the operation signal sent from the wireless communication unit 32 of the client terminal device 3. Moreover, the wireless communication unit 13 in the present invention, for example, as information transmission section, sends the content information (compressed content information) according to the operation signal that has been sent from the wireless communication unit 32 of the client terminal device 3, obtained by the execution of the output information obtainment program 1231 by the CPU 121, to the wireless communication unit 32 of the client terminal device 3.

The various kinds of AV apparatus 2 connected to the server device 1 includes, for example, as shown in FIG. 2, a television device 21 and the like. The various kinds of AV apparatus 2 operate corresponding to the control by the control unit 12 of the server device 1. The various kinds of AV apparatus 2 outputs, for example, content information (image information and audio information) to the encoder 11 of the server device 1 corresponding to the control.

Here, the various kinds of AV apparatuses 2 includes not only the television device 21 shown in FIG. 2, but also suitable arbitrary AV apparatus such as a video recorder, a personal video recorder (PVR), a tuner of the broadcasting satellite (BS) broadcast or the communication satellite (CS) broadcast, a set top box (STB), a digital versatile disk (DVD) player, an audio device, and the like.

[Configuration of Client Terminal Device]

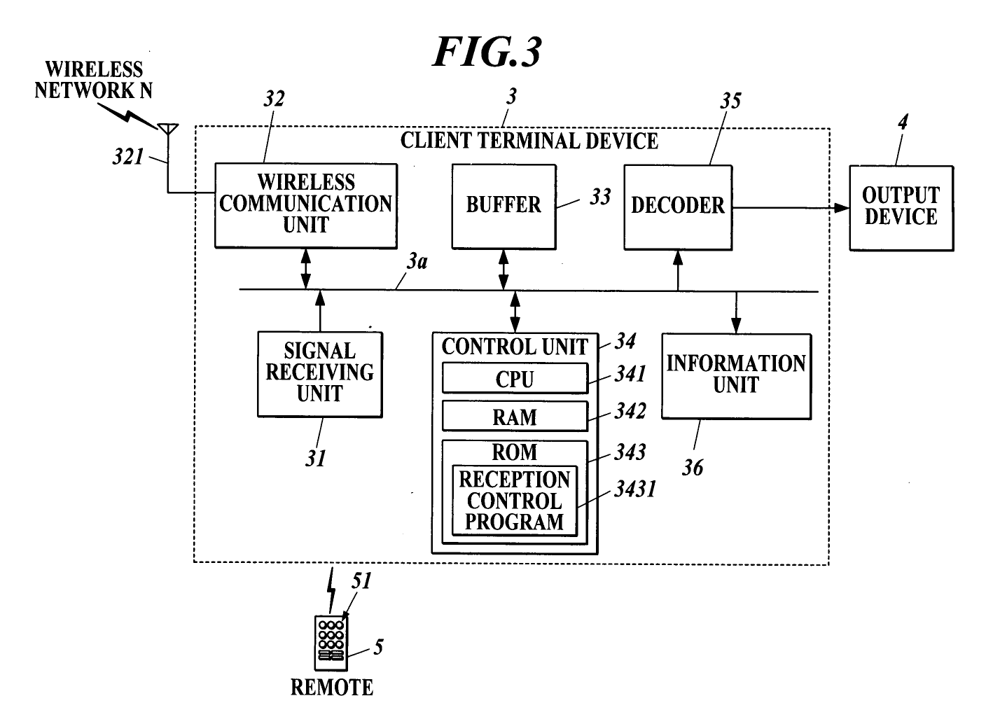

Each of the client terminal device 3 comprises, for example, as shown in FIG. 3, a signal reception unit 31, a wireless communication unit 32, a buffer 33, a control unit 34, a decoder 35, an information unit 36, and the like. Each unit is connected with each other through a bus 3a. Further, the client terminal device 3 is connected with the output device 4 as output section, and is configured to be able to be operated with the remote 5.

The signal reception unit 31 receives, for example, the operation signal sent from the remote 5 as signal reception section.

The wireless communication unit 32 has a similar configuration as that of the wireless communication unit 13 of the server device 1, and sends and receives various kinds of information with the server device 1 through the wireless network N. In particular, the wireless communication unit 32 includes an antenna 321 to send and receive radio signals with the server device 1, a radio frequency (RF) converter (not shown), a wireless LAN card (not shown) to connect with a wireless LAN according to the Bluetooth standard and the IEEE 802.11 standard, and the like.

In particular, the wireless communication unit 32 in the present invention, for example, as signal transmission section, sends the operation signal that has been sent from the remote 5, received with the signal reception unit 31, to the wireless communication unit 13 of the server device 1. Moreover, the wireless communication unit 32 in the present invention receives, for example, the content information sent from the wireless communication unit 13 of the server device 1, and the like.

As storage section, the buffer 33 temporarily stores the content information (compressed content information) that has been sent from the server device 1 corresponding to the operation signal sent by the wireless communication unit 32. The amount of the content information (compressed content information) that the buffer 33 stores increases when the content information (compressed content information) is received from the server device 1 and decreases when the content information is outputted to the output device 4.

The control unit 34 comprises, for example, as shown in FIG. 3, CPU 341, RAM 342, ROM 343, timing part (not shown) and the like.

The CPU 341 performs various control operations according to various processing programs stored in the ROM 343 for the server device 3.

The RAM 342 is provided with a program storage region to expand the processing program to be executed by the CPU 341 and the like, and a data storage region to input data, a processing result produced at the time of the execution of the processing program, and the like.

The ROM 343 stores the system program executable by the server device 3, the various processing programs executable by the system program, the data used at the time of the execution of the various processing programs, the data of the processing results of the operation processing by the CPU 341, and the like. Here, the programs are stored in the ROM 343 in the form of the program codes capable of being read by a computer.

In particular, for example, as shown in FIG. 3, an output information obtainment program 3431 and the like are stored in the ROM 343.

A reception regulation program 3431 makes a CPU 341 actualize the function to inhibit the reception of the operation signals sent from the remote 5 by the signal reception unit 31 until completion of outputting the content information temporarily stored in the buffer 33 to the output device 4, after the reception of one operation signal from the remote 5. Moreover, the reception regulation program 3431 makes the CPU 341 actualize the function to inform the inhibition of the reception of the operation signals sent from the remote 5 by the signal reception unit 31, with the information unit 36 as information section during the inhibition.

In particular, for example, when the signal reception unit 31 receives the one operation signal from the remote 5, the CPU 341 executes the reception regulation program 3431 and calculate the time (output completion time) required until all of the content information are outputted to the output device 4, based on the amount of the content information (compressed content information) stored in the buffer 33 at the point of time when the signal reception unit 31 receives the one operation signal from the remote 5. In addition, the CPU 341 makes a timer unit (not shown) start timing, and inhibits the reception of the operation signals sent from the remote 5 by the signal reception unit 31 until the timed time exceeds the calculated time for completion of output. Subsequently, when the timed time exceeds the calculated time for completion of output, the CPU 341 cancels the inhibition. Moreover, the CPU 341 executes the reception regulation program 3431 to inform the inhibition of the reception of the operation signals sent from the remote 5 by the signal reception unit 31, with the information unit 36 during the inhibition.

The CPU 341 functions as reception regulation section by executing the reception regulation program 3431.

For example, as output control section, the decoder 35 performs the control of outputting the content information (compressed content information) stored in the buffer 33 to the output device 4. In particular, for example, the decoder 35 performs the processing according to the file format of the compressed content information, to the compressed content information (compressed image information and compressed audio information) stored in the buffer 33, and decodes the compressed content information to the content information (image information and audio information). Subsequently, the decoder 53 outputs the content information to the output device 4.

As the information section, the information unit 36 informs the inhibition of the reception of the operation signals sent from the remoter 5 by the signal reception unit 31, in accordance with the control of the CPU 341, which has executed the reception regulation program 3431, during the inhibition. In particular, for example, the information unit 36 is a light emitting diode (LED) or the like, and the information unit 37 is lightened during the inhibition of the reception of the operation signals sent from the remote 5 by the signal reception unit 31.

For example, as output section, the output device 4 outputs the content information (image information and audio information) inputted from the decoder 35. In particular, for example, the output device 4 is provided with a monitor (not shown), which outputs image information, a speaker (not shown), which outputs audio information, and the like.

The remote 5 is provided with, for example, various input buttons 51 and the like as shown in FIG. 3. For example, when an input button among the various input buttons 51 is depressed by a user, the remote 5 sends the operation signal corresponding to the input button, to the signal reception unit 31 of the client terminal device 3.

<Reception Regulation Processing>

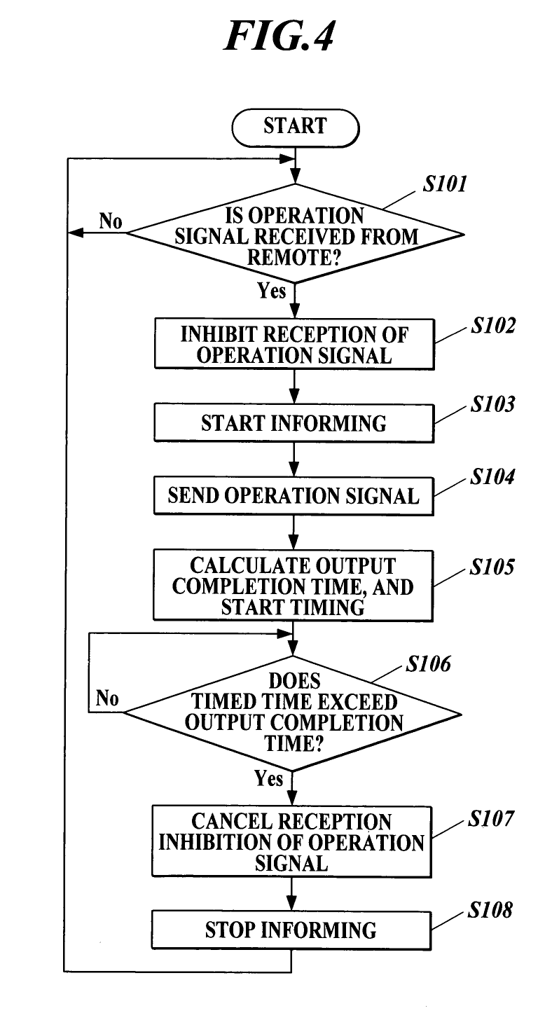

Next, the processing pertaining to the reception regulation of the operation signals from the remote 5 by the client terminal device 3 of the client server system S is described with reference to the flowchart of FIG. 4.

First, the CPU 341 of the client terminal device 3 judges whether the signal reception unit 31 has received the operation signal sent from the remote 5 or not (Step In step S101, when the CPU 341 judges that the signal reception unit 31 has not received the operation signal sent from the remote 5 (Step S101; No), the CPU 341 repeatedly performs the processing of Step S101.

On the other hand, when the CPU 341 judges that the signal reception unit 31 has received the operation signal sent from the remote 5 in Step S101 (Step S101; Yes), the CPU 341 executes the reception regulation program 3431 to inhibit the reception of the operation signals sent from the remote 5 by the signal reception unit 31 (Step S102), and starts the informing with the information unit 36 (Step S103).

Subsequently, the CPU 341 sends the operation signal received by the signal reception unit 31 at Step S101 to the wireless communication unit 13 of the server device 1 from the wireless communication unit 32 (Step S104).

Subsequently, the CPU 341 executes the reception regulation program 3431 and calculate a time (output completion time) required until all of the content information are outputted to the output device 4, based on the amount of the content information (compressed content information) stored in the buffer 33, and makes the timer unit (not shown) start timing (Step S105).

Subsequently, the CPU 341 judges whether the timed time of the timing which started at Step S105 has exceeded the time for completion of output, calculated at Step S105, or not (Step S106).

When the CPU 341 judges that the timed time has not exceeded the time for completion of output at Step S106 (Step S106; No), the CPU 341 repeatedly performs the processing of Step S106.

On the other hand, when the CPU 341 judges that the timed time has exceeded the time for completion of output at Step S106 (Step S106; Yes), the CPU 341 cancels the inhibition of the reception of the operation signals sent from the remote 5 by the signal reception unit 31, which inhibition had started at Step S102 (Step S107), and stops the informing with the information unit 36, which had started at Step S103 (Step S108). Then, the CPU 341 again repeatedly performs the processing after Step S101.

According to the client terminal device 3 and the client server system S of the present invention, which have been described above, by executing the reception regulation program 3431 by the CPU 341 of the client terminal device 3, the reception of the operation signals sent from the remote 5 by the signal reception unit 31 can be inhibited until the completion of output of the content information temporarily stored in the buffer 33 to the output device 4, after the reception of one operation signal from the remote 5. That is, even when a user unnecessarily operates the remote 5 and unnecessary operation signals are sent from the remote 5, the signal reception unit 31 of the client terminal device 3 does not receive the unnecessary operation signals. Consequently, the client terminal device 3 does not perform operations that the user does not desire, unlike the conventional client terminal device. Furthermore, since the period during which the reception of the operation signals is inhibited is not restricted to a certain period, unlike the conventional client terminal device, the operation signals can be received at more suitable timing.

In particular, within the execution of the reception regulation program 3431 by the CPU 341, it is possible to calculate the time (time for completion of output) required until all of the content information have been outputted to the output device 4, based on the amount of the content information stored in the buffer 33 at the point of time when the signal reception unit 31 has received the one operation signal from the remote 5, and to inhibit the reception of the operation signals sent from the remote 5 by the signal reception unit 31 until the calculated time has elapsed.

Consequently, since the operation signal received by the signal reception unit 31 after the one operation signal is, a valid operation signal transmitted after the ascertainment of the completion of the output of the content information according to the operation signal received by the signal reception unit 31 before the one operation signal, the client terminal device 3 can receive the operation signals at more suitable timing.

Moreover, by executing the reception regulation program 3431, the CPU 341 can inform the inhibition of the reception of the operation signals with the information unit 37 during the inhibition. Consequently, the problem that a user thinks that no operation signals have been sent to the client terminal device 3 and feels uneasy can be solved. Furthermore, since the misunderstanding of the user such that no operation signals have been sent to the client terminal device 3 is solved, it is also expectable that no operation signals are sent unnecessarily.

Here, the present invention is not limited to the embodiment described above, and suitable variations and modifications can be performed so long as it does not depart from the scope of the subject matter of the invention.

For example, the processing pertaining to the reception regulation of the operation signals from the remote 5 by the client terminal device 3 of the client server system S of the present embodiment (FIG. 4) may be those of a first and a second modified examples of the processing, which will be described later.

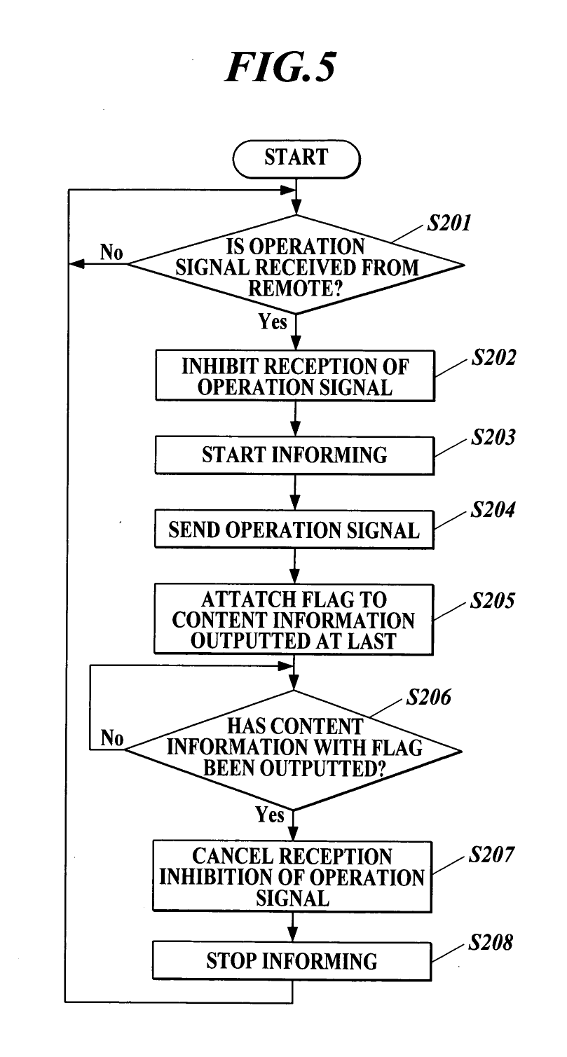

First of all, the first modified example of the processing pertaining to the reception regulation of the operation signals from the remote 5 by the client terminal device 3 of the client server system S is described with reference to the flowchart of FIG. 5.

Here, when the signal reception unit 31 receives one operation signal from the remote 5, the reception regulation program 3431 makes the CPU 341 actualize the function of putting a mark (e.g. a flag) on the content information lastly outputted to the output device 4, among all of the content information (compressed content information) stored in the buffer 33 at the point of time when the signal reception unit 31 has received the one operation signal from the remote 5. The reception of the operation signals sent from the remote 5 is inhibited by the signal reception unit 31, until the content information with the flag is outputted to the output device 4. Then the inhibition is cancelled when the content information with the flag is outputted to the output device 4.

Moreover, like the embodiment described above, the CPU 341 executes the reception regulation program 3431 to inform the inhibition of the reception of the operation signals sent from the remote 5 by the signal reception unit 31, with the information unit 36 during the inhibition.

First, the CPU 341 of the client terminal device 3 judges whether the signal reception unit 31 has received the operation signal sent from the remote 5 or not (Step S201).

In step S201, when it is judged that the signal reception unit 31 has not received the operation signal sent from the remote 5 (Step S201; No), the CPU 341 repeatedly performs the processing of Step S201.

On the other hand, when it is judged that the signal reception unit 31 has received the operation signal sent from the remote 5 in Step S201 (Step S201; Yes), the CPU 341 executes the reception regulation program 3431 to inhibit the reception of the operation signals sent from the remote 5 by the signal reception unit 31 (Step S202), and starts the informing with the information unit 36 (Step S203).

Subsequently, the CPU 341 sends the operation signal received by the signal reception unit 31 at Step S201 to the wireless communication unit 13 of the server device 1 from the wireless communication unit 32 (Step S204).

Subsequently, the CPU 341 executes the reception regulation program 3431, and puts a mark (flag) on the content information lastly outputted to the output device 4 among all of the content information (compressed content information) stored in the buffer 33 (Step S205).

Subsequently, the CPU 341 judges whether the content information with the flag at Step S205 has been outputted to the output device 4 or not (Step S206).

When the CPU 341 judges that the content information with the flag has not been outputted at Step S206 (Step S206; No), the CPU 341 repeatedly performs the processing of Step S206.

On the other hand, when the CPU 341 judges that the content information with the flag has been outputted at Step S206 (Step S206; Yes), the CPU 341 cancels the inhibition of the reception of the operation signals sent from the remote 5 by the signal reception unit 31, which inhibition had started at Step S202 (Step S207), and stops the informing with the information unit 36, which had started at Step S203 (Step S208). Subsequently, the CPU 341 again repeatedly performs the processing after Step S201.

According to the client terminal device 3 and the client server system S in the first modified example described above, within the execution of the reception regulation program 3431 by the CPU 341, a mark (e.g. a flag) is put on the content information lastly outputted to the output device 4 among all of the content information stored in the buffer 33 at the point of time when the signal reception unit 31 has received the one operation signal from the remote 5, and the reception of the operation signals sent from the remote 5 by the signal reception unit 31 can be inhibited until the content information with the flag is outputted to the output device 4.

Consequently, since the operation signal received by the signal reception unit 31 after the one operation signal is a valid operation signal sent after the ascertainment of the completion of the output of the content information according to the operation signal received by the signal reception unit 31 before the one operation signal, the client terminal device 3 can receive the operation signals at more suitable timing.

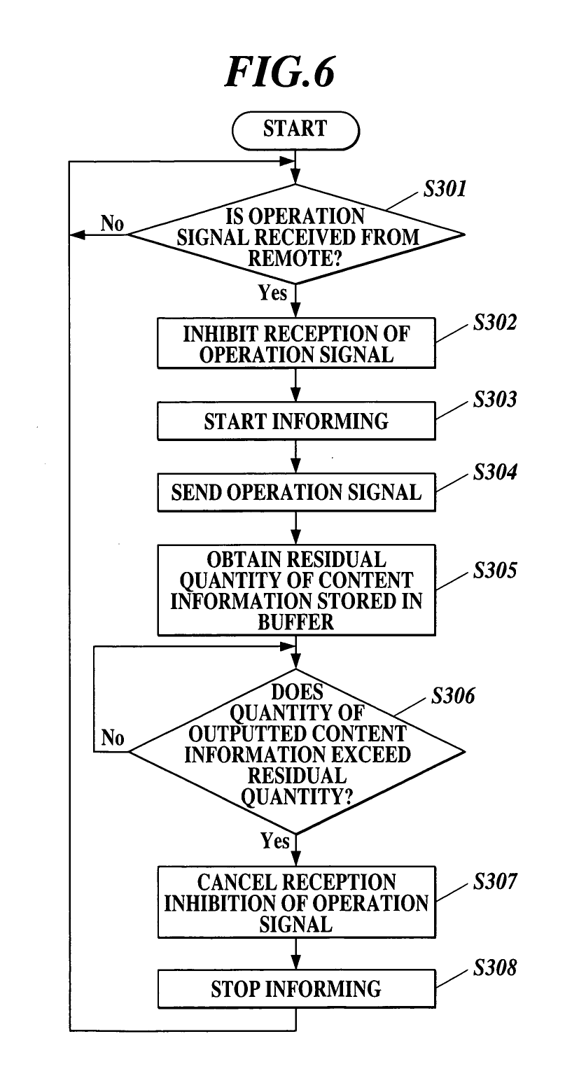

Next, the second modified example of the processing pertaining to the reception regulation of the operation signals from the remote 5 by the client terminal device 3 of the client server system S is described with reference to the flowchart of FIG. 6.

Here, when the signal reception unit 31 receives one operation signal from the remote 5, the reception regulation program 3431 makes the CPU 341 actualize the function to obtain the residual quantity of the content information (compressed content information) stored in the buffer 33 at the point of time when the signal reception unit 31 has received the one operation signal from the remote 5. The reception of the operation signals sent from the remote 5 is inhibited by the signal reception unit 31 until the amount of the content information outputted to the output device 4 exceeds the residual quantity from the point of time when the CPU 341 has obtained the residual quantity. Subsequently, the inhibition is canceled when the amount of the content information outputted to the output device 4 from the point of time when the CPU 341 has obtained the residual quantity exceeds the residual quantity.

Moreover, like the embodiment described above, the CPU 341 executes the reception regulation program 3431 to inform the inhibition of the reception of the operation signals sent from the remote 5 by the signal reception unit 31, with the information unit 36 during the inhibition.

First, the CPU 341 of the client terminal device 3 judges whether the signal reception unit 31 has received the operation signal sent from the remote 5 or not (Step. S301).

In step S301, when the CPU 341 judges that the signal reception unit 31 has not received the operation signal sent from the remote 5 (Step S301; No), the CPU 341 repeatedly performs the processing of Step S301.

On the other hand, when the CPU 341 judges that the signal reception unit 31 has received the operation signal sent from the remote 5 in Step S301 (Step S301; Yes), the CPU 341 executes the reception regulation program 3431 to inhibit the reception of the operation signals sent from the remote 5 by the signal reception unit 31 (Step S302), and starts the informing with the information unit 36 (Step S303).

Subsequently, the CPU 341 sends the operation signal received by the signal reception unit 31 at Step S301 to the wireless communication unit 13 of the server device 1 from the wireless communication unit 32 (Step S304).

Subsequently, the CPU 341 executes the reception regulation program 3431 to obtain the residual quantity of the content information (compressed content information) stored in the buffer 33 (Step S305).

Subsequently, the CPU 341 judges whether the amount of the content information outputted to the output device 4 after Step S305 has exceeded the residual quantity obtained at Step S305 or not (Step S306).

When the CPU 341 judges that the amount of the outputted content information has not exceeded the residual quantity at Step S306 (Step S306; No), the CPU 341 repeatedly performs the processing of Step S306.

On the other hand, when the CPU 341 judges that the amount of the outputted content information has exceeded the residual quantity at Step S306 (Step S306; Yes), the CPU 341 cancels the inhibition of the reception of the operation signals sent from the remote 5 by the signal reception unit 31, which inhibition had started at Step S302 (Step S307), and stops the informing with the information unit 36, which had started at Step S303 (Step S308). Subsequently, the CPU 341 again repeatedly performs the processing after Step S301.

According to the client terminal device 3 and the client server system S in the second modified example, which have been described above, the CPU 341 obtains the residual quantity of the content information stored in the buffer 33 at the point of time when the signal reception unit 31 has received the one operation signal from the remote 5 by executing the reception regulation program 3431, and can inhibit the reception of the operation signals transmitted from the remote 5 by the signal reception unit 31 until the amount of the content information outputted to the output device 4 exceeds the residual quantity from the point of time when the CPU 341 has obtained the residual quantity.

Consequently, since the operation signals received by the signal reception unit 31 after the one operation signal are valid operation signals sent after the ascertainment of the completion of the output of the content information according to the operation signals received by the signal reception unit 31 before the one operation signal, the client terminal device 3 can receive the operation signals at more suitable timing.

Moreover, not only the various kinds of AV apparatus 2, for example, but also suitable arbitrary apparatus capable of supplying content information as the output information thereof to the client terminal device 3 may be connected to the server device 1. Furthermore, the content information may not only be supplied from the various kinds of AV apparatuses 2 connected to the server device 1, but may also be previously stored in the ROM 123 of the server device 1.

Moreover, the way of the informing by the information unit 36 is not limited as long as it can inform a user of the inhibition of the reception of the operation signals sent from the remote 5. In particular, the informing may be performed not only in the manner of lightening the LED during the inhibition of the reception of the operation signals like the embodiment described above, but also, for example, in the manner of varying the period of flickering of the LED to inform the approach of the cancellation of the inhibition of the reception of the operation signals by shortening the period of the flickering. Moreover, the informing of the approach of the cancellation of the inhibition of the reception of the operation signals may be performed, for example, in the way of counting down the time from the beginning of the inhibition of the reception of the operation signals, to the cancellation of the inhibition by seven-segment LED's arranged to be able to display numerals, or an LED of plurality of colors.

Moreover, the information unit 36 may perform the informing by sounds, for example, besides the display. In particular, when operation signals are inputted during the inhibition of the reception of operation signals, the invalidity of the receiving of the operation signals may be informed by sounds.

What is claimed is:

1. A client server system, comprising:
a client terminal device; further comprising:
a signal reception section to receive operation signals sent from a remote controller;
a signal transmission section to send the operation signals received by the signal reception section to a server device;
a storage section to temporarily store output information corresponding to the operation signals sent by the signal transmission section, the output information sent from the server device;
an output control section to control outputting the output information stored in the storage section to output section;
a reception regulation section to inhibit reception of the operation signals sent from the remote controller by the signal reception section, until completion of outputting the output information temporarily stored in the storage section to the output section after reception of one operation signal from the remote controller; and
an informing section to inform inhibition while the reception regulation section inhibits reception of the operation signals; and
the server device connected with the client terminal device through a wireless network to send and receive information; further comprising:
an output information obtainment section to obtain the output information corresponding to the operation signals sent by the signal transmission section; and
an information transmission section to send the output information obtained by the output information obtainment section to the client terminal device.

2. A client terminal device that sends and receives information with a server device connected to the client terminal device through a wireless network, comprising:
a signal reception section to receive operation signals sent from a remote controller;
a signal transmission section to send the operation signals received by the signal reception section to the server device;
a storage section to temporarily store output information corresponding to the operation signals sent by the signal transmission section, the output information sent from the server device;
an output control section to control outputting the output information stored in the storage section to output section; and
a reception regulation section to inhibit reception of the operation signals sent from the remote controller by the signal reception section, until completion of outputting the output information temporarily stored in the storage section to the output section after reception of one operation signal from the remote controller.

3. The client terminal device according to claim 2, wherein the reception regulation section calculates a time required until all of the output information is outputted to the output section, based on an amount of the output information stored in the storage section at a point of time when the signal reception section received the one operation signal from the remote controller, and inhibits reception of the operation signals sent from the remote controller by the signal reception section until the time calculated elapse.

4. The client terminal device according to claim 2, wherein the reception regulation section puts a mark on output information which is lastly outputted to the output section, among the output information stored in the storage section at a point of time when the signal reception section received the one operation signal from the remote controller, and inhibits reception of the operation signals sent from the remote controller by the signal reception section until the output information which is lastly outputted, with the mark on, is outputted to the output section.

5. The client terminal device according to claim 2, wherein the reception regulation section obtains a residual quantity of the output information stored in the storage section at a point of time when the signal reception section received the one operation signal from the remote controller, and inhibits reception of the operation signals sent from the remote controller by the signal reception section until an amount of the output information outputted to the output section since a point of time when the residual quantity has been obtained, exceeds the residual quantity.

6. The client terminal device according to claim 2, further comprising an informing section to inform inhibition while the reception regulation section inhibits reception of the operation signals.
